(19) United States
(12) Patent Application Publication
(10) Pub. No.: US 2026/0242022 A1
(43) Pub. Date: Aug. 20, 2026

(54) System For Creating Downforce On A Wheeled Vehicle

(71) Applicant: Frederick & Cederna Architects LLC, Potomac, MD (US)

(72) Inventor: Douglas FREDERICK, Potomac, MD (US)

(73) Assignee: Frederick & Cederna Architects LLC, Potomac, MD (US)

(21) Appl. No.: 19/643,086

(22) Filed: Apr. 9, 2026

Related U.S. Application Data
(63) Continuation-in-part of application No. 19/261,196, filed on Jul. 7, 2025.
Application No. 19/261,196 is a continuation of application No. 18/755,177, filed on Jun. 26, 2024, now Pat. No. 12,351,264.
(60) Provisional application No. 63/523,739, filed on Jun. 28, 2023.

(51) Int. Cl. B62J 17/00; B62D 35/00

(52) U.S. Cl. CPC B62J 17/00; B62D 35/005; B62D 35/007

(57) ABSTRACT

A vehicle, in accordance with the present disclosure, includes a frame, a front wheel support, a rear wheel support, and a gyroscope. A downforce generating (DFG) system is mounted to the vehicle. The DFG system includes a front DFG wing support, a pitch motor, a rear DFG wing support, a rotational motor, and a front downforce generating (DFG) wing mounted to the front DFG wing support. A wing controller is operatively connected to the gyroscope, the pitch motor, and the rotational motor. The wing controller is configured to adjust, in real time, a position of the front DFG wing and the rear DFG wing in response to signals received from the gyroscope to maintain a substantially fixed orientation of the first leading edge and the second leading edge relative to the support surface as the frame pivots between positive and negative roll angles.

### CROSS-REFERENCE TO RELATED APPLICATIONS

This application is a continuation in part of U.S. Application No. 19/261,196, filed July 7, 2025, which application is a continuation of U.S. Application No. 18/755,177, filed June 26, 2024, which application claims the benefit of U.S. Provisional Application No. 63/523,739 filed on June 28, 2023. The entire disclosure of the above application is incorporated herein by reference.

### FIELD

The present disclosure relates to the art of wheeled vehicles and, more particularly, to a system for providing downforce to a two-wheeled vehicle.

### BACKGROUND

When exposed to acceleration forces, motorcycles or two-wheeled vehicles tend to rotate upwards about a rear axle (also known as a wheelie). Acceleration forces delivered through rear wheels tend to cause front wheels to lift as torque generated by a power unit exceeds the weight of the front of the vehicle. Downforce (downward force), which can be applied to counteract this lift is generated by vehicle body shape as well as force created by wings or spoilers mounted to the vehicle. Vehicles transition between multiple forces when moving. For example, a vehicle experiences different forces during acceleration, during braking, and when turning or cornering. Downforce can improve traction, grip, and road adhesion in any of these circumstances.

Motorcycles include multiple surfaces that contribute to generating downward force and improving aerodynamics. For example, gas tanks are shaped to reduce drag, engines are covered or shielded by fairings that reduce drag and enhance downward forces, and winglets may be added to further improve downward forces. In addition, a rider’s body position contributes to motorcycle aerodynamics and downward force generation.

Downward force increases contact patch and grip with road surfaces at front and/or rear tires during acceleration, braking, and turning. Maintaining a positive contact and grip between vehicle wheels and tires and road surfaces increases driving performance and rider safety. Accordingly, it would be desirable to provide a system for increasing downward force on a vehicle, particularly a motorcycle during each stage of driving (acceleration, braking, and turning).

### SUMMARY

This section provides a general summary of the disclosure, and is not a comprehensive disclosure of its full scope or all of its features.

A vehicle, in accordance with the present disclosure, includes a frame configured to pivot relative to a support surface through both positive and negative roll angles, a front wheel support coupled to the frame, a front wheel rotatably connected to the front wheel support about a front wheel axis, a rear wheel support pivotally mounted to the frame, a rear wheel rotatably supported by the rear wheel support about a rear wheel axis, and a gyroscope mounted to one of the frame, the front wheel support, and the rear wheel support. A downforce generating (DFG) system is mounted to the vehicle. The DFG system includes a front DFG wing support mounted to the front wheel support, a pitch motor connected to the front DFG wing support, a rear DFG wing support mounted to the rear wheel support, a rotational motor connected to the rear DFG wing support, and a front downforce generating (DFG) wing mounted to the front DFG wing support and operatively connected to the pitch motor. The front DFG wing includes a first leading edge. A rear DFG wing is mounted to the rear DFG wing support and operatively connected to the rotational motor. The rear DFG wing includes a second leading edge. A wing controller is operatively connected to the gyroscope, the pitch motor, and the rotational motor. The wing controller is configured to adjust, in real time, a position of the front DFG wing and the rear DFG wing in response to signals received from the gyroscope to maintain a substantially fixed orientation of the first leading edge and the second leading edge relative to the support surface as the frame pivots between positive and negative roll angles.

In other features, a wing support operatively connects the rear DFG wing to the rear DFG wing support, the wing support being configured to pivot about an axis that is substantially perpendicular to a center axis of rotation of the rear wheel.

In other features, the rear wheel support comprises a swingarm, the rear DFG wing having a V-shape including a wing connector, a first wing portion, a second wing portion, the wing connector being connected to the wing support.

In other features, the front DFG wing support includes a first wing support member connected to the front wheel support at a first side of the front wheel and a second wing support member connected to front wheel support at a second side of the front wheel.

In other features, the front DFG wing includes a first wing panel having a first leading edge portion connected to the first wing support member and a second wing panel having a second leading edge portion connected to the second wing support member.

In other features, the pitch motor is connected to the first wing panel and the second wing panel, the wing controller being configured to adjust, in real time, the position of the front DFG wing to maintain each of the first leading edge portion and the second leading edge portion in a substantially parallel relationship with the support surface as the frame pivots between positive and negative roll angles.

In other features, a rotational motor operatively connects to the first wing panel, the second wing panel, and the wing controller, the wing controller being configured command the rotational motor to pitch the first wing panel and the second wing panel about an axis that is substantially parallel to the front wheel axis.

In other features, a linkage extends between the controller and the pitch motor.

In other features, the linkage extends between and operatively connect the pitch motor and the rotational motor to the controller.

A two-wheeled vehicle, in accordance with the present disclosure, includes a frame, a front wheel connected to the frame through a front wheel support, the front wheel being rotatable about a front wheel axis, and a rear wheel connected to the frame through a rear wheel support. The rear wheel being rotatable about a rear wheel axis. A downforce generating wing is mounted at one of a front wheel support and the rear wheel support. The downforce generating wing includes an aerodynamic surface having a leading edge. An electric motor is operatively connected to the downforce generating wing. A gyroscope is arranged on the two-wheeled vehicle. The gyroscope is configured to detect a lean angle of the two-wheeled vehicle relative to a road surface. A brake sensor is arranged on the two-wheeled vehicle. A throttle sensor is arranged on the two-wheeled vehicle. The throttle sensor is configured to detect an amount of acceleration of the two-wheeled vehicle. A wing controller operatively is connected to the electric motor, the gyroscope, the brake sensor, and the throttle sensor. The wing controller is configured to command, in real time, the electric motor to adjust a position of the downforce generating wing in response to signals received from at least one of the gyroscope, the brake sensor, and the throttle sensor to maintain the leading edge at a substantially fixed orientation relative to the road surface as the frame pivots between positive and negative roll angles.

In other features, a wing support operatively connects the downforce generating wing to the rear wheel support, the wing support being configured to pivot about an axis that is substantially perpendicular to a center axis of rotation of the rear wheel.

In other features, the rear wheel support comprises a swingarm, the downforce generating wing having a V-shape including a wing connector, a first wing portion, a second wing portion, the wing connector being connected to the wing support.

In other features, the one of the front wheel support and the rear wheel support includes a first wing support member connected at a first side of a corresponding one of the front wheel and the rear wheel and a second wing support member connected to the one of the front wheel support and the rear wheel support at a second side of the one of the front wheel and the rear wheel.

In other features, the downforce generating wing includes a first wing panel having a first leading edge portion connected to the first wing support member and a second wing panel having a second leading edge portion connected to the second wing support member.

In other features, the electric motor is connected to the first wing panel and the second wing panel, the wing controller being configured to command, in real time, the electric motor to adjust the position of the downforce generating wing to maintain each of the first leading edge portion and the second leading edge portion in a substantially parallel relationship with the road surface as the frame pivots between positive and negative roll angles.

In other features, another electric motor is operatively connected to the first wing panel, the second wing panel, and the wing controller, the wing controller being configured command the another electric motor to pitch the first wing panel and the second wing panel about an axis that is substantially parallel to the front wheel axis.

In other features, a linkage extends between the controller and the pitch motor.

In other features, the linkage extends between and operatively connect the pitch motor and the rotational motor to the controller.

A method of creating downforce on a wheel of a two-wheeled vehicle, in accordance with the present disclosure, includes detecting an orientation of the two-wheeled vehicle through a vehicle lean angle sensor, sending the orientation to a wing controller operatively connected to a motor, activating the motor to adjust a position of a first wing panel and a second wing panel of a downforce generating wing mounted to a wheel support of the two-wheeled vehicle, rotating the downforce generating wing about a pivot axis defined by the motor, and maintaining, with the wing controller, in real time, a substantially fixed orientation of the downforce generating wing relative to a support surface with the motor through changes in roll angle.

In other features, the maintaining, with the wing controller, in real time, the substantially fixed orientation of the downforce generating wing relative to a support surface includes maintaining the first wing panel and the second wing panel in a substantially parallel relationship with the support surface.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a left side view of a motorcycle including a downforce generating wing system including a first downforce generating wing mounted to a front wheel support and a second downforce generating wing mounted to a rear wheel support, in accordance with a non-limiting example;

FIG. 2 is a front view of the motorcycle of FIG. 1 in a leaning configuration depicting the first and second downforce generating wings maintaining a substantially horizontal orientation relative to a road surface, in accordance with a non-limiting example;

FIG. 3 is a block diagram illustrating a system for controlling the downforce generating wing system of FIG. 1, in accordance with the present disclosure;

FIG. 4 is an upper right perspective view of a motorcycle including a downforce generating wing system including two front downforce generating wings and two rear downforce generating wings, in accordance with another aspect of the present disclosure;

FIG. 5 is an upper right side view of the motorcycle of FIG. 4, in accordance with the present disclosure;

FIG. 6 is a front view of the motorcycle of FIG. 4, in accordance with the present disclosure;

FIG. 7 is a front view of the motorcycle of FIG. 4 in a leaning configuration depicting the two front downforce generating wings and the two rear downforce generating wings maintaining a substantially horizontal orientation relative to a road surface, in accordance with a non-limiting example;

FIG. 8 is a left side view of the motorcycle of FIG. 4, in accordance with the present disclosure;

FIG. 9 is a left side view of the motorcycle of FIG. 4, in accordance with another aspect of the present disclosure; and

FIG. 10 is a block diagram illustrating a system for controlling the two front downforce generating wings and the two rear downforce generating wings, in accordance with the present disclosure.

Corresponding reference numerals indicate corresponding parts throughout the several views of the drawings.

### DETAILED DESCRIPTION

Example embodiments will now be described more fully with reference to the accompanying drawings.

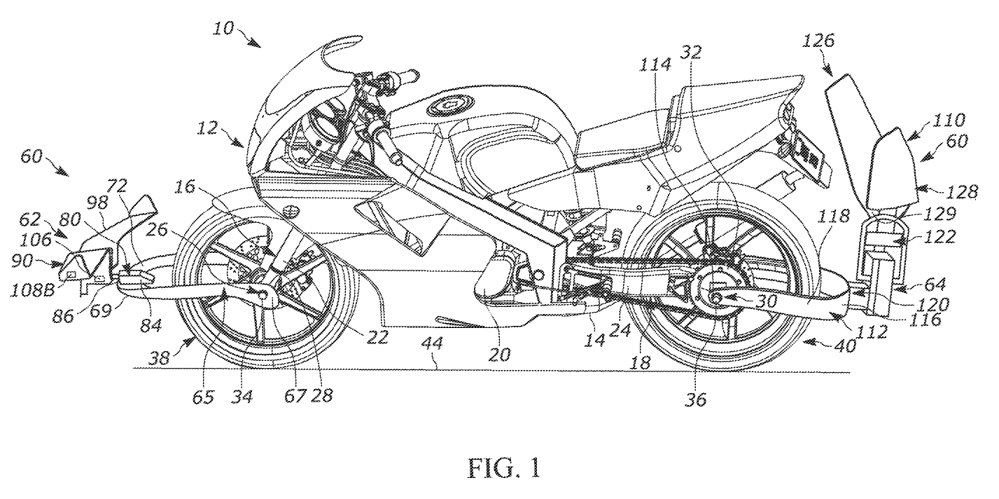

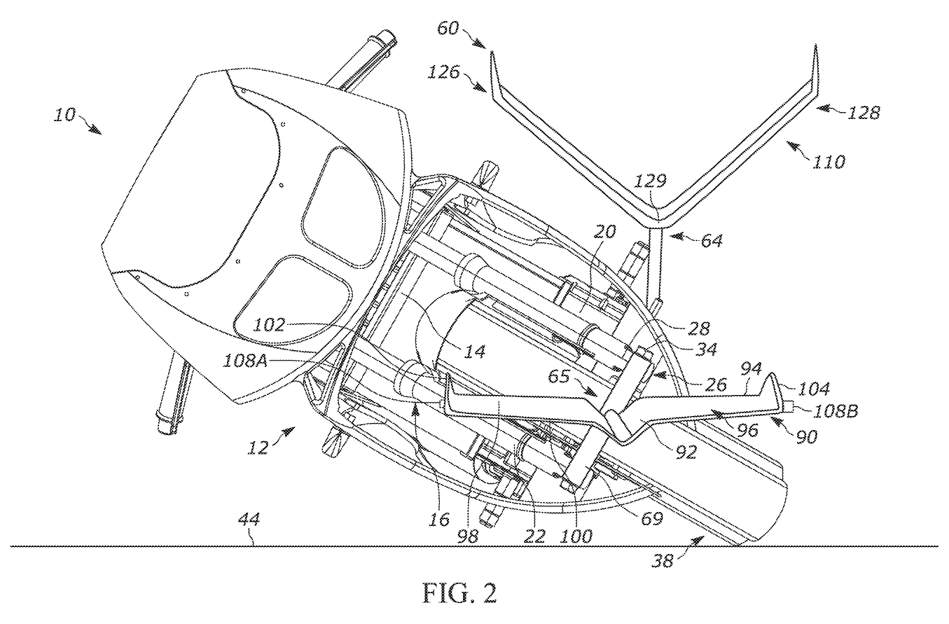

A vehicle, in accordance with a non-limiting example, is indicated generally at 10 in FIGS. 1 and 2. Vehicle 10 is shown in the form of a two-wheeled vehicle or motorcycle 12 having a frame 14, a front wheel support 16, a rear wheel support 18, and a motor 20. The frame 14 may pivot between positive and negative roll angles as shown in FIG. 2 as the motorcycle 12 negotiates curves along a roadway. Motor 20 may take on a variety of forms including internal combustion engines, electric motors, as well as hybrid motors that include aspects of internal combustion engines and electric motors. At this point, it should be understood that the term frame may encompass a tubular frame, a chassis, or other form of support structure.

In one non-limiting example, front wheel support 16 takes the form of a front fork 22 and rear wheel support 18 takes the form of a rear swingarm 24. Front fork 22 includes a front axle support member 26 having a front axle mounting portion 28 and rear swingarm 24 includes a rear axle support member 30 including a rear axle mounting portion 32. Front axle mounting portion 28 receives a front axle 34 and rear axle mounting portion 32 receives a rear axle 36. A front wheel and tire 38 is rotationally coupled to front axle support member 26 through front axle 34. Likewise, a rear wheel and tire 40 is coupled to rear axle support member 30 through rear axle 36. Front axle 34 defines a center axis of rotation of front wheel and tire 38 and rear axle 36 defines a center axis of rotation of rear wheel and tire 40. Front wheel and tire 38 and rear wheel and tire 40 rest and/or ride upon a road surface 44.

When turning, motorcycle 12 may experience roll angles between about +28° and about -28° from road surface 44 such as shown in FIG. 2. In a non-limiting example, motorcycle 12 includes a downforce generating (DFG) system 60 enhances contact between front wheel and tire 38 and rear wheel and tire 40 and road surface 44 particularly during vehicle accelerations and turning. DFG system 60 includes a front DFG wing system 62 associated with front axle support member 26 and a rear DFG wing system 64 associated with rear axle support member 30.

To enhance traction, DFG system 60 acts on unsprung components of motorcycle 12. That is, none of the forces generated by DFG system 60 are absorbed by vehicle suspension components that may be arranged in front fork 22 or connected with rear swingarm 24. The downforce is passed directly through front wheel and tire 38 and rear wheel and tire 40 into the road surface 44. As will be detailed herein, the force(s) generated by DFG system 60 is maintained along an axis that is substantially perpendicular to road surface 44 regardless of the orientation (roll angle) of motorcycle 12.

Reference will continue to FIG. 1 in describing front DFG wing system 62. In accordance with the present disclosure, front downforce generating wing system 62 includes a front wing support 65 connected to front wheel support 16. Front wing support 65 includes a first end 67 mounted at front axle mounting portion 28, a second end 69, and an intermediate portion 72 that straddles front wheel and tire 38. Second end 69 of front wing support 65 is cantilevered and extends forwardly of front wheel and tire 38.

In a non-limiting example, a motor support 80 is connected to front wing support 65 at second end 69. A rotational motor 84 is mounted to motor support 80. Rotational motor 84 includes an output shaft (not separately labeled) that defines an axis of rotation. In one non-limiting example, the axis of rotation may extend 70°. In another non-limiting example, the axis of rotation may be less than 70°. A pitch motor 86 from part of rotational motor 84. Pitch motor 86 may take the form of a linear actuator. A front downforce generating (DFG) wing 90 is connected to the output shaft of rotational motor 84. As will be detailed more fully herein, rotational motor 84 pivots front DFG wing 90 about the rotational axis in order to maintain a substantially perpendicular downward force vector regardless of motorcycle orientation. In addition to rotational motor 88, a pitch motor 86 is connected to motor support 80.

In a non-limiting example, front DFG wing 90 includes a leading edge 92, a trailing edge 94, and an aerodynamic surface 96 that is defined between leading edge 92 and trailing edge 94. Aerodynamic surface 96 includes an upper surface portion 98 and a lower surface portion 100. Aerodynamic surface 96 extends between a first wing tip 102 and a second wing tip 104. In a non-limiting example, a wing angle sensor 106 may be mounted to lower surface portion 100. It should however be noted that the particular mounting location of wing angle sensor 106 may vary.

In further accordance with an exemplary embodiment, a first proximity sensor 108A is mounted to the first wing tip 102 and a second proximity sensor 108B is mounted to the second wing tip 104. First proximity sensor 108A and second proximity sensor 108B detect a distance between road surface 44 and corresponding ones of the first wing tip 102 and the second wing tip 104 as vehicle 10 takes on a lean angle, as shown in FIG. 2, particularly on banked road surfaces.

Rear DFG wing system 64 includes a rear DFG wing 110 connected to rear swingarm 24 through a rear DFG wing support 112. Rear DFG wing support 112 includes a first end 114 connected to rear swingarm 24, a second end 116, and an intermediate portion 118. Intermediate portion 118 straddles rear wheel and tire 40. Rear DFG wing system 64 further includes a first motor 120 and a second motor 122 mounted to rear DFG wing support 112. First motor 120 is configured to rotate rear DFG wing 110 about a first or pitch axis and second motor 122 is configured to rotate rear DFG wing 110 about a second or rotational axis.

In accordance with an aspect of the present disclosure, rear DFG wing 110 includes a first wing panel 126 and a second wing panel 128 that converge at a wing connector member 129 thereby forming a V-shape. Wing connector member 129 is connected to first motor 120 and second motor 122 and may be rotated about each of the rotational axis and the pitch axis to impart a downwardly directed force on rear wheel and tire 40.

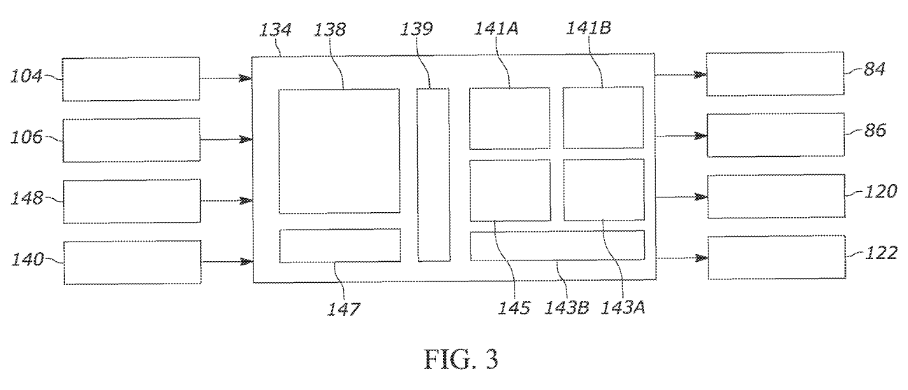

In accordance with an aspect of the present disclosure, rotational motor 84, pitch motor 86, are connected to a wing controller 134 as shown in FIG. 3. Wing controller 134 includes a central processing unit (CPU) 138, a non-volatile memory 139 that stores instructions for operation of front DFG wing 90 and rear DFG wing system 64, a first angle control module 141A, a second angle control module 141B. a first pitch control module 143A, a second pitch control module 143B, and a proximity analyzer module 145. In addition, wing controller 134 may also include a gyroscope 147. Gyroscope 147 may form part of wing controller 134 or may be mounted separately. Wing controller 134 may further be connected to a throttle sensor 148 and a brake sensor 149.

Wing controller 134 commands rotational motor 84 and first motor 120 to selectively adjust the angular position of corresponding ones of front DFG wing 90 and rear DFG wing 110. Wing controller 134 further commands pitch motor 86 and second motor 122 to selectively adjust the pitch of corresponding ones of front DFG wing 90 and rear DFG wing 110 to ensure that the downward force vector remains substantially perpendicular relative to road surface 44. Adjusting the rotational position and pitch ensures that the leading edge 92 of front DFG wing 90 is maintained substantially fixed orientation, e.g., parallel to the road surface 44 such that the downward force vector remains substantially perpendicular relative to road surface 44 regardless of motorcycle orientation.

In accordance with an aspect of the present disclosure, relying on instructions in non-volatile memory 139, CPU 137 communicates with gyroscope 147, with first angle control module 141A, second angle control module 141B, first pitch control module 143A, and second pitch control module 143B as well as throttle inputs from throttle sensor 148 and brake sensor 149 to determine an amount of adjustment needed for front DFG wing 90 and rear DFG wing 110 to accommodate changes in pitch of motorcycle 12 to generate a downforce vector that passes perpendicularly into road surface 44. While shown as including a single wing controller 134 having a single CPU 137, vehicle 10 may include separate controllers associated with corresponding ones of pitch movement and rotational movement of front DFG wing 90 and rear DFG wing 110.

In addition, wing controller 134 may employ proximity analyzer module 145 to communicate with first proximity sensor 108A and second proximity sensor 108B to determine distance between first wing tip 102, second wing tip 104, and road surface 44. On a banked curve, one or the other of first wing tip 102 or second wing tip 104 may come close to contacting road surface 44. In such cases, a downforce strictly perpendicular to the center of gravity would not be as desirable. In order to avoid such contact, and maximize downforce as much as practical, wing controller 134 may adjust a rotational position of front DFG wing 90 that may cause the force vector to pass into road surface 44 to be other than perpendicular to the center of the earth, however adjust to parallel to the road surface for a short period of time e.g. the period of time motorcycle 12 is on the banked curve. For example, the first wing tip 102 and/or the second wing tip 104 will be controlled to be substantially parallel to the road surfaces.

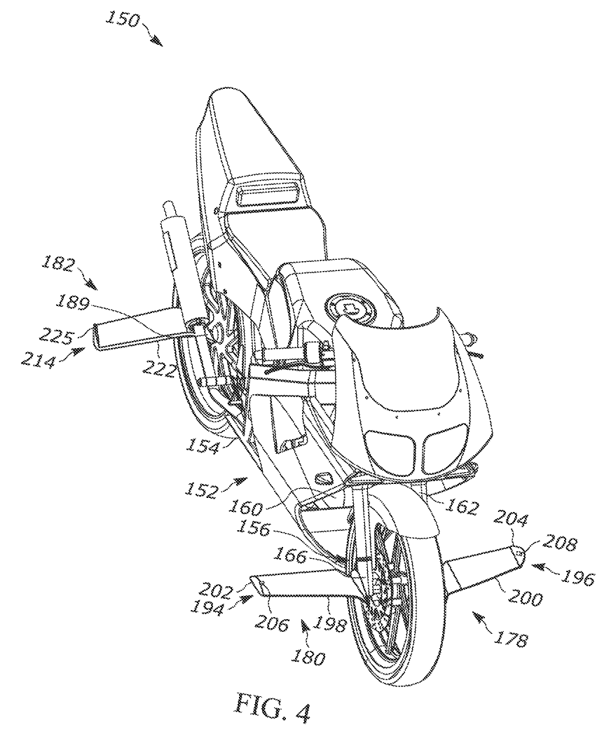

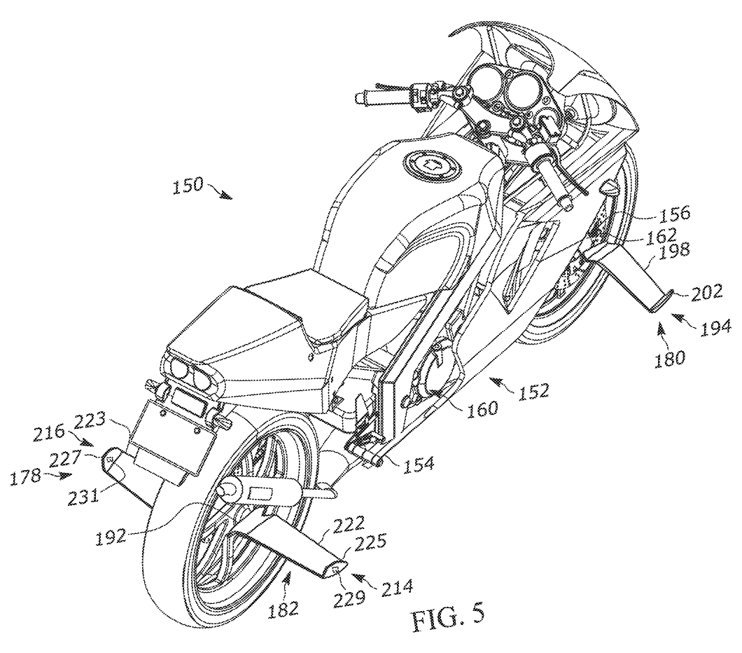

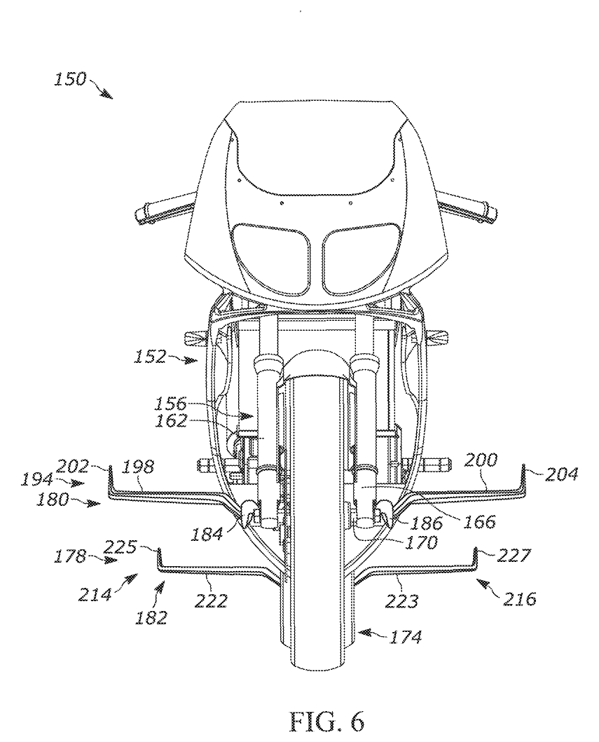

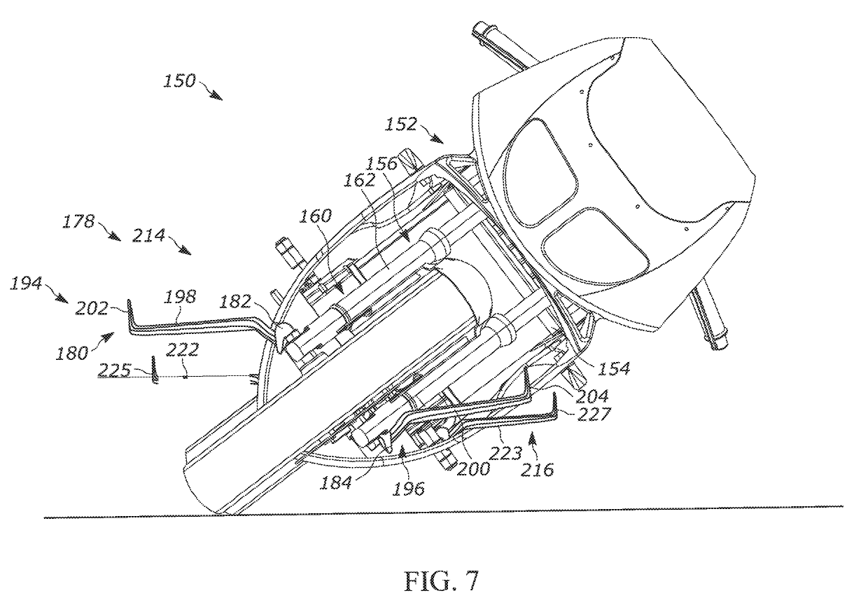

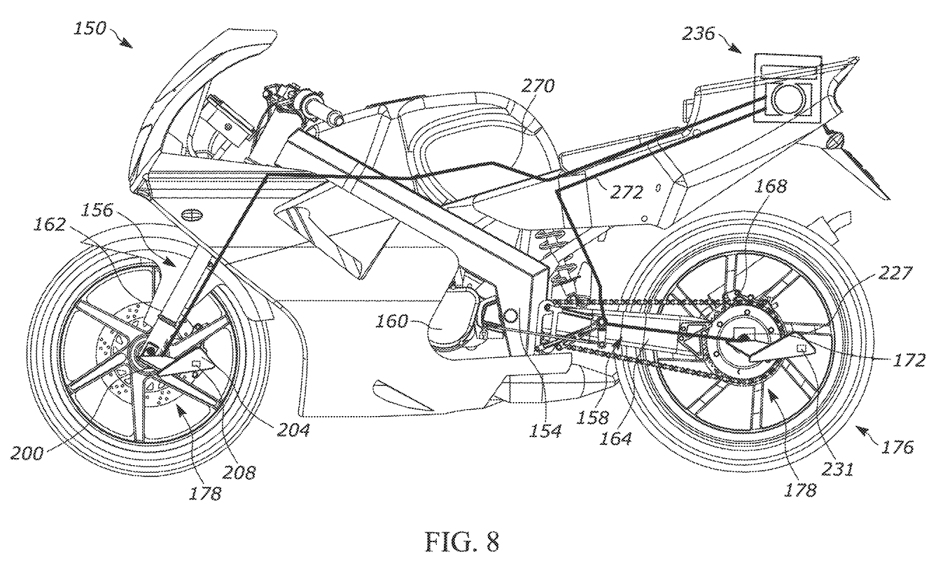

Reference will now follow to FIGS. 4, 5, and 6 in describing a vehicle 150 in accordance with another aspect of the present disclosure. Vehicle 150 takes the form of a two-wheeled vehicle or motorcycle 152 having a frame 154, a front wheel support 156, a rear wheel support 158 (FIG. 8), and a motor 160. The frame 154 may pivot between positive and negative roll angles as shown in FIG. 7 as the motorcycle 12 negotiates curves along a roadway. Motor 160 may take on a variety of forms including internal combustion engines, electric motors, as well as hybrid motors that include aspects of internal combustion engines and electric motors. At this point, it should be understood that the term frame may encompass a tubular frame, a chassis, or other form of support structure.

In one non-limiting example, front wheel support 156 takes the form of a front fork 162 and rear wheel support 158 takes the form of a rear swingarm 164 (FIG. 8). Front fork 162 includes a front axle support 166 and rear swingarm 164 includes a rear axle support 168. Front axle support 166 includes a front axle 170 defining a first axis of rotation and which rotatably supports a front wheel and tire 174 and rear axle support 168 includes a rear axle 172 defining a second axis of rotation and which rotatably supports a rear wheel and tire 176.

In accordance with the present disclosure, motorcycle 152 includes a downforce generating (DFG) system 178. DFG system 178 includes a front DFG wing 180 mounted to front wheel support 156 and a rear DFG wing 182 mounted to rear wheel support 158. DFG system 178 adjusts a position of front DFG wing 180 and rear DFG wing 182 as motorcycle 152 undergoes positive and negative roll angle changes such as shown in FIG. 7. Front DFG wing 180 includes a first wing support 184 and a second wing support 186. First wing support 184 extends from front axle support 166 in a first direction along the first axis of rotation and second wing support 186 extends from front axle support 166 in a second direction along the first axis of rotation.

In further accordance with the present disclosure, rear DFG wing 182 includes a third wing support 189 and a fourth wing support 192. Third wing support 189 extends from rear axle support 168 in a first direction along the second axis of rotation and fourth wing support 192 extends from rear axle support 168 in a second direction along the second axis of rotation.

In accordance with the present disclosure, a first wing panel 194 is mounted to first wing support 184 and a second wing panel 196 is mounted to second wing support 186. First wing panel 194 includes a first leading edge 198 and second wing panel 196 includes a second leading edge 200. First wing panel 194 also includes a first wing tip 202 and second wing panel 196 includes a second tip. A first tip sensor 206 is mounted to first wing tip 202 and a second tip sensor 208 is mounted to second wing tip 204.

A third wing panel 214 is mounted to third wing support 189 and a fourth wing panel 216 is mounted to fourth wing support 190. Third wing panel 214 includes a third leading edge 222 and fourth wing panel 216 includes a fourth leading edge 223. Third wing panel 214 includes a third wing tip 225 and fourth wing panel 216 includes a fourth wing tip 227. A third tip sensor 229 is mounted to third wing tip 225 and a fourth tip sensor 231 is mounted to fourth wing tip 227.

As shown in FIG. 8, DFG system 178 is operatively connected to a control system 234 mounted to motorcycle 152. Control system 234, as will be detailed more fully herein, controls a position of each of the first wing panel 194, the second wing panel 196, the third wing panel 214, and the fourth wing panel 216 to generate a downforce on front wheel and tire 174 and rear wheel and tire 176, respectively. In most scenarios, the downforce has a vector that is substantially perpendicular to road surface 44 regardless of the lean angle of motorcycle 152.

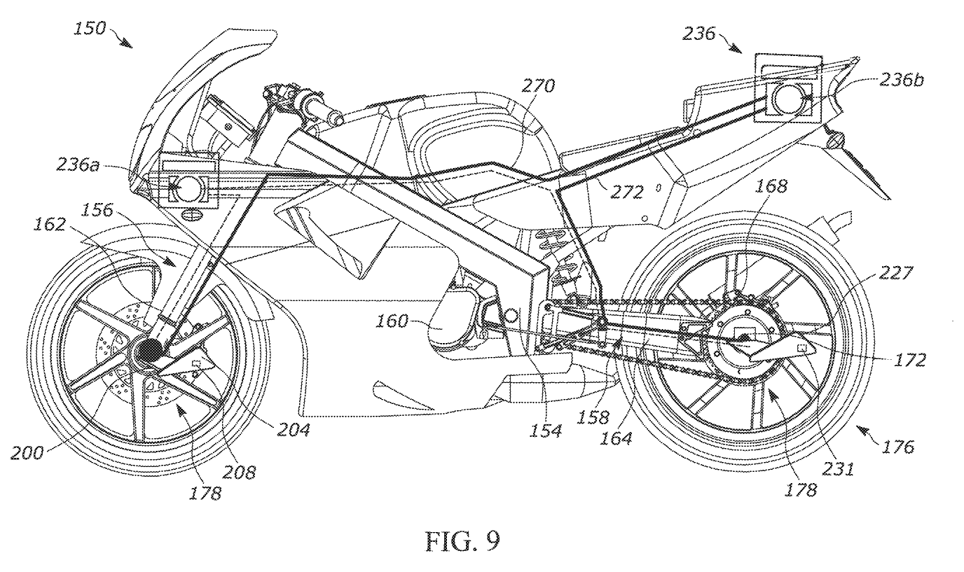

In accordance with an aspect of the present disclosure, control system 234 includes a wing controller 236 that controls both pitch and roll of DFG system 178. At this point it should be understood that while shown and described with a single wing controller 236, motorcycle 152 may include dedicated controllers, as shown in FIG. 9. That is motorcycle 152 may include a first wing controller 236a that determines and controls tilt or pitch and a second wing controller 236b that determines and controls rotation of front DFG wing 180 and rear DFG wing 182 to accommodate tile angle changes of motorcycle 152. Further, each of the dedicated controllers 236a and 236b may include fail safe features. The fail safe features allow one of the controllers 236a and 236b to control both the front DFG wing 180 and the rear DFG wing 182 in the event that another of the controllers 236a and 236b experiences an operational abnormality.

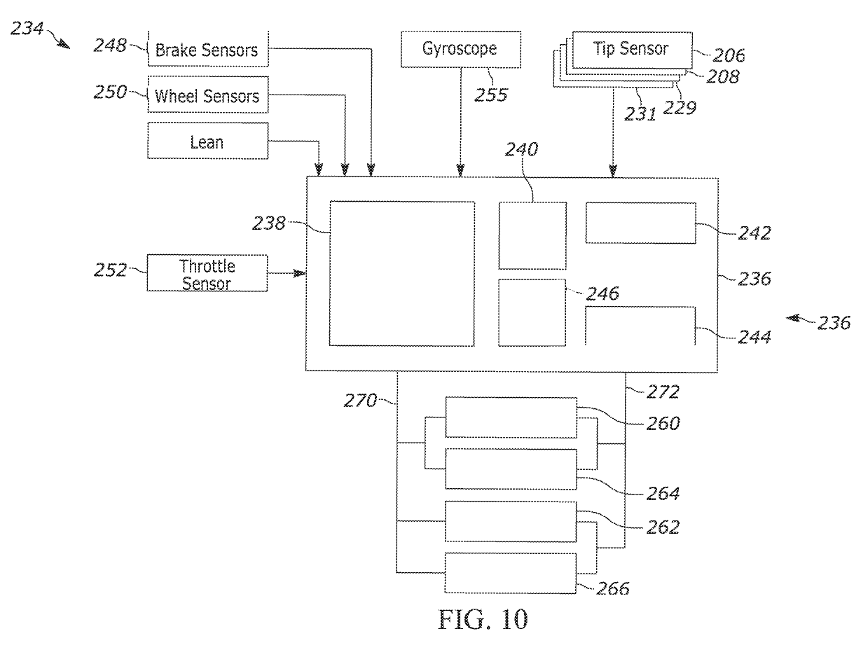

In accordance with an aspect of the present disclosure illustrated in FIG. 10, wing controller 236 includes a non-volatile memory 240 stores a set of instructions used by CPU 238 to control DFG system 178 in a manner that will be detailed more fully herein. Wing controller 236 establishes pitch changes for front DFG wing 180 and rear DFG wing 182 to accommodate tile angle changes of motorcycle 152, and angle rotational changes for front DFG wing 180 and rear DFG wing 182 to accommodate steering angle changes of motorcycle 152.

More specifically, wing controller 236 includes a tilt or pitch motor control module 242 that determines pitch change metrics for front DFG wing 180 and rear DFG wing 182 to accommodate tile angle changes of motorcycle 152. Wing controller 236 also includes a rotational motor control module 244 that determines angle change metrics for front DFG wing 180 and rear DFG wing 182 to accommodate changes in handlebar (not separately labeled) position of motorcycle 152.

Wing controller 236 further includes a proximity detection module 246 that monitors distance between each of the first wing tip 202, second wing tip 204, third wing tip 2257, and fourth wing tip 227 and road surface 44 as motorcycle 152 transitions between left and right lean angles, on particularly on banked surfaces. That is, many motorcycle race courses include banked curves.

Proximity detection module 246 receives feedback from each of the first tip sensor 206, second tip sensor 208, third tip sensor 229, and fourth tip sensor 213 regarding a distance between each of the first wing tip 202, second wing tip 204, third wing tip 2257, and fourth wing tip 227 and road surface 44 in a banked curve. Control system 234 will function to prevent inadvertent contact when control system 234 adjusts the position of DFG system 178 to maintain downforce. If a potential contact is indicated, control system 234 will adjust any change in position of DFG system 178 to avoid the contact. In such cases, the downforce vector may not be perpendicular to road surface 44 for a short period of time.

In accordance with an aspect of the present disclosure, wing controller 236 is operatively connected to brake sensors 248, wheel speed sensors 250, a throttle sensor 252, and a gyroscope 255. Gyroscope 255 provides feedback to wing controller 236 regarding tilt angle of motorcycle 152. Gyroscope 255 may be part of wing controller 236 or mounted separately on motorcycle 152. In response to feedback signals provided by gyroscope 255, and received from the throttle sensor 252, the brake sensors 248, and the wheel speed sensors 250. Wing controller 236 commands the necessary pitch changes and angle changes, in real time, for front DFG wing 180 and rear DFG wing 182 to accommodate tilt angle changes of motorcycle 152 to generate the desired downforce vector.

In order to achieve the necessary pitch changes, a first pitch motor 260 is mounted to first wing support 184 and operatively connected to first wing panel 194 and second wing panel 196. A second pitch motor 262 is mounted to second wing support 186 and operatively connected to third wing panel 214 and fourth wing panel 216. Angle changes are achieved through operation of a first rotational motor 264 and a second rotational motor 266. First rotational motor 264 is mounted to first wing support 184 and operatively connected to first wing panel 194 and second wing panel 196 and second rotational motor 266 is mounted to second wing support and operatively connected to third wing panel 214 and fourth wing panel 216.

First pitch motor 260, second pitch motor 262, first rotational motor 264, and second rotational motor 266 may take the form of servo motors that are operatively connected to wing controller 236. As shown in FIG. 8, a first linkage 270 extends between wing controller 236 and first pitch motor 260 and first rotational motor 264 and a second linkage 272 extends between wing controller 236 and second pitch motor 262 and second rotational motor 266. First linkage 270 carries pitch and rotation signal changes from controller 235 and front DFG wing 180 and second linkage 272 carries pitch and rotation changes from wing controller 236 to rear DFG wing 182.

### Separate controllers

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure.

Further, although each of the embodiments is described above as having certain features, any one or more of those features described with respect to any embodiment of the disclosure can be implemented in and/or combined with features of any of the other embodiments, even if that combination is not explicitly described. In other words, the embodiments described are not mutually exclusive, and permutations of one or more embodiments with one another remain within the scope of this disclosure.

The terminology used herein is for the purpose of describing particular example embodiments only and is not intended to be limiting. As used herein, the singular forms "a", "an" and "the" may be intended to include the plural forms as well, unless the context clearly indicates otherwise. The terms "comprises," "comprising," “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being "on", “engaged to”, "connected to" or "coupled to" another element or layer, it may be directly on, engaged, connected, or coupled to the other element or layer, or intervening elements or layers may be present. In contrast, when an element is referred to as being "directly on," “directly engaged to”, "directly connected to" or "directly coupled to" another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term "and/or" includes any and all combinations of one or more of the associated listed items.

When the terms "about" or “substantially” are used in this specification in connection with a numerical value, it is intended that the associated numerical value includes a manufacturing or operational tolerance (e.g., ±10%) around the stated numerical value. Moreover, when the terms "generally" or "substantially" are used in connection with geometric shapes, it is intended that precision of the geometric shape is not required but that latitude for the shape is within the scope of the disclosure. Furthermore, regardless of whether numerical values or shapes are modified as "about," “generally,” or "substantially," it will be understood that these values and shapes should be construed as including a manufacturing or operational tolerance (e.g., ±10%) around the stated numerical values or shapes.

Although the terms first, second, third, etc. may be used herein to describe various elements, components, regions, layers and/or sections, these elements, components, regions, layers, and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” "beneath,” "below,” "lower,” "above,” "upper", “top”, “bottom”, “side”, and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as "below,” "beneath", or “bottom” and/or other elements or features would then be oriented "above" the other elements or features. Thus, the example terms "below" and “bottom” can encompass both an orientation of above and below. The device may be otherwise oriented (rotated 90 degrees or at other orientations) and the spatially relative descriptors used herein interpreted accordingly.

What is claimed is:

1. A vehicle comprising:
a frame configured to pivot relative to a support surface through both positive and negative roll angles;
a front wheel support coupled to the frame;
a front wheel rotatably connected to the front wheel support about a front wheel axis;
a rear wheel support pivotally mounted to the frame;
a rear wheel rotatably supported by the rear wheel support about a rear wheel axis;
a gyroscope mounted to one of the frame, the front wheel support, and the rear wheel support; and
a downforce generating (DFG) system mounted to the vehicle, the DFG system including:
a front DFG wing support mounted to the front wheel support;
a pitch motor connected to the front DFG wing support;
a rear DFG wing support mounted to the rear wheel support;
a rotational motor connected to the rear DFG wing support;
a front downforce generating (DFG) wing mounted to the front DFG wing support and operatively connected to the pitch motor, the front DFG wing including a first leading edge;
a rear DFG wing mounted to the rear DFG wing support and operatively connected to the rotational motor, the rear DFG wing including a second leading edge; and
a wing controller operatively connected to the gyroscope, the pitch motor, and the rotational motor, the wing controller being configured to adjust, in real time, a position of the front DFG wing and the rear DFG wing in response to signals received from the gyroscope to maintain a substantially fixed orientation of the first leading edge and the second leading edge relative to the support surface as the frame pivots between positive and negative roll angles.

2. The vehicle according to claim 1, further comprising a wing support operatively connecting the rear DFG wing to the rear DFG wing support, the wing support being configured to pivot about an axis that is substantially perpendicular to a center axis of rotation of the rear wheel.

3. The vehicle according to claim 2, wherein the rear wheel support comprises a swingarm, the rear DFG wing having a V-shape including a wing connector, a first wing portion, a second wing portion, the wing connector being connected to the wing support.

4. The vehicle according to claim 1, wherein the front DFG wing support includes a first wing support member connected to the front wheel support at a first side of the front wheel and a second wing support member connected to front wheel support at a second side of the front wheel.

5. The vehicle according to claim 4, wherein the front DFG wing includes a first wing panel having a first leading edge portion connected to the first wing support member and a second wing panel having a second leading edge portion connected to the second wing support member.

6. The vehicle according to claim 5, wherein the pitch motor is connected to the first wing panel and the second wing panel, the wing controller being configured to adjust, in real time, the position of the front DFG wing to maintain each of the first leading edge portion and the second leading edge portion in a substantially parallel relationship with the support surface as the frame pivots between positive and negative roll angles.

7. The vehicle according to claim 6, further comprising: a rotational motor operatively connected to the first wing panel, the second wing panel, and the wing controller, the wing controller being configured command the rotational motor to pitch the first wing panel and the second wing panel about an axis that is substantially parallel to the front wheel axis.

8. The vehicle according to claim 7, further comprising: a linkage extending between the controller and the pitch motor.

9. The vehicle according to claim 8, wherein the linkage extends between and operatively connect the pitch motor and the rotational motor to the controller.

10. A two-wheeled vehicle comprising:
a frame;
a front wheel connected to the frame through a front wheel support, the front wheel being rotatable about a front wheel axis;
a rear wheel connected to the frame through a rear wheel support, the rear wheel being rotatable about a rear wheel axis;
a downforce generating wing mounted at one of a front wheel support and the rear wheel support, the downforce generating wing including an aerodynamic surface having a leading edge;
an electric motor operatively connected to the downforce generating wing;
a gyroscope arranged on the two-wheeled vehicle, the gyroscope being configured to detect a lean angle of the two-wheeled vehicle relative to a road surface;
a brake sensor arranged on the two-wheeled vehicle;
a throttle sensor arranged on the two-wheeled vehicle, the throttle sensor being configured to detect an amount of acceleration of the two-wheeled vehicle; and
a wing controller operatively connected to the electric motor, the gyroscope, the brake sensor, and the throttle sensor, the wing controller being configured to command, in real time, the electric motor to adjust a position of the downforce generating wing in response to signals received from at least one of the gyroscope, the brake sensor, and the throttle sensor to maintain the leading edge at a substantially fixed orientation relative to the road surface as the frame pivots between positive and negative roll angles.

11. The two-wheeled vehicle according to claim 10, further comprising a wing support operatively connecting the downforce generating wing to the rear wheel support, the wing support being configured to pivot about an axis that is substantially perpendicular to a center axis of rotation of the rear wheel.

12. The two-wheeled vehicle according to claim 11, wherein the rear wheel support comprises a swingarm, the downforce generating wing having a V-shape including a wing connector, a first wing portion, a second wing portion, the wing connector being connected to the wing support.

13. The two-wheeled vehicle according to claim 10, wherein the one of the front wheel support and the rear wheel support includes a first wing support member connected at a first side of a corresponding one of the front wheel and the rear wheel and a second wing support member connected to the one of the front wheel support and the rear wheel support at a second side of the one of the front wheel and the rear wheel.

14. The two-wheeled vehicle according to claim 13, wherein the downforce generating wing includes a first wing panel having a first leading edge portion connected to the first wing support member and a second wing panel having a second leading edge portion connected to the second wing support member.

15. The two-wheeled vehicle according to claim 14, wherein the electric motor is connected to the first wing panel and the second wing panel, the wing controller being configured to command, in real time, the electric motor to adjust the position of the downforce generating wing to maintain each of the first leading edge portion and the second leading edge portion in a substantially parallel relationship with the road surface as the frame pivots between positive and negative roll angles.

16. The two-wheeled vehicle according to claim 15, further comprising: another electric motor operatively connected to the first wing panel, the second wing panel, and the wing controller, the wing controller being configured command the another electric motor to pitch the first wing panel and the second wing panel about an axis that is substantially parallel to the front wheel axis.

17. The two-wheeled vehicle according to claim 16, further comprising: a linkage extending between the controller and the pitch motor.

18. The two-wheeled vehicle according to claim 17, wherein the linkage extends between and operatively connects the pitch motor and the rotational motor to the controller.

19. A method of creating downforce on a wheel of a two-wheeled vehicle comprising:
detecting an orientation of the two-wheeled vehicle through a vehicle lean angle sensor;
sending the orientation to a wing controller operatively connected to a motor;
activating the motor to adjust a position of a first wing panel and a second wing panel of a downforce generating wing mounted to a wheel support of the two-wheeled vehicle;
rotating the downforce generating wing about a pivot axis defined by the motor; and
maintaining, with the wing controller, in real time, a substantially fixed orientation of the downforce generating wing relative to a support surface with the motor through changes in roll angle.

20. The method of claim 19, wherein maintaining, with the wing controller, in real time, the substantially fixed orientation of the downforce generating wing relative to a support surface includes maintaining the first wing panel and the second wing panel in a substantially parallel relationship with the support surface.
